(19) United States
(12) Patent Application Publication
(10) Pub. No.: US 2001/0023636 A1
(43) Pub. Date: Sep. 27, 2001

(54) Method for forming a film on a swash plate for a swash plate type compressor

(76) Inventors: Manabu Sugiura, Kariya-shi (JP); Yoshifumi Kato, Kariya-shi (JP); Hiroaki Kayukawa, Kariya-shi (JP); Toshihisa Shimo, Kariya-shi (JP); Takayuki Kato, Kariya-shi (JP)

Correspondence Address: MORGAN & FINNEGAN, L.L.P., 345 Park Avenue, New York, NY, 10154, US

(21) Appl. No.: 09/804,088

(22) Filed: Mar. 12, 2001

(30) Foreign Application Priority Data
Mar. 21, 2000 (JP) 2000-077419

(51) Int. Cl. F16J 1/10

(52) U.S. Cl. 92/129

(57) ABSTRACT

The object of the present invention is to offer methods for forming a film of a high quality on a swash plate for a swash plate type compressor simply and the film formed swash plate.

A wet sliding layer is formed by applying a film-forming material to a PTFE (polytetrafluoroethylene) film, and is dried to be half-cured. Then the half-cured sliding layer is adhered to the preheated swash plate, and is transferred to the swash plate by pressing. The dried and fixed sliding layer is formed on the region of the swash plate by peeling the PTFE film from it.

### BACKGROUND OF THE INVENTION

The present invention relates to a method for forming a film on a swash plate for a swash plate type compressor and to the film formed swash plate thereof.

The swash plate fixed around a drive shaft at a certain angle, or the swash plate inclinably attached to the drive shaft, is rotated in accordance with the rotation of the drive shaft. Pistons are reciprocated in accordance with the rotation of the drive shaft, to increase and decrease the capacity in a compression chamber defined in the compressor. The swash plate slides with shoes as sliding members, and the rotation of the swash plate is converted into the reciprocating movement of the piston through the shoes, whereby the refrigerant is sucked and compressed. When the compressor starts to operate, the refrigerant reaches sliding portions of the swash plate and the refrigerant washes off remaining lubricant oil around the sliding portions, before the lubricating oil reaches there. Therefore, the swash plate slides in the dry condition having little lubricating oil. Thus, the swash plate slides in a very severe condition.

It is required that the swash plate has sliding properties such as an anti-seizure property and an anti-abrasion property in such a condition. So the following suggestions are offered. A hard material is added to a swash plate member made of an aluminum series material to improve its anti-abrasion property. A heat treatment is performed on a swash plate member made of a steel series to raise its hardness and improve its anti-abrasion property. A film is formed so that the lubricating coating material is applied on a swash plate member or on an intermediately treated swash plate member.

In recent suggestions, a method for forming a film by applying the lubricating coating material on the swash plate and the piston of a compressor and the like is disclosed in Japanese Unexamined Patent Publications No. 10-26081 and No. 11-173263.

In a roller coating method according to Japanese Unexamined Patent Publication No. 10-26081, a coating material is applied on a peripheral surface of a metal roller, and the coating material on the metal roller is transferred on a peripheral surface of a printing roller, which is made of a synthetic rubber, and then the coating material transferred on the peripheral surface of the printing roller is applied to a piston and the like. At this time, the metal roller contacts the printing roller, and the printing roller contacts the piston to be coated. The coating material on the metal roller is adjusted to be predetermined thickness by a comma roller before transferred to the printing roller.

In a pad method according to Japanese Unexamined Patent Publication No. 11-173263, a coating material prepared on a concave printing plate at a predetermined thickness and in a predetermined shape is transferred to a pad, and the coating material on the pad is printed on the swash plate to be coated.

In a coating method according to Japanese Unexamined Patent Publication No. 10-26081, however, a line is formed on a coating film passing between a comma roller and a metal roller when a foreign substance is got into a clearance therebetween. The coating film having lines is transferred to the printing roller, and is applied on the piston sliding on the printing roller, so the quality of the film is deteriorated. Unless the foreign substance is removed, the line is formed on every film of a subsequent piston to be filmed.

In a coating method according to Japanese Unexamined Patent Publication No. 11-173263, a film tends to crease, for the pad is deformed ununiformly. When a contacting surface of the pad with the swash plate is plane, a film is not satisfactorily formed since air is involved therebetween. When the contacting surface of the pad is in a convex curved shape so that it prevents air from being involved in, the thickness of the film is not uniform. For the closer to the center of the contacting surface it is, the stronger the contacting force of the pad against the swash plate becomes. Therefore, the film needs to be polished so that the thickness of it is adjusted after drying and calcination process. The portion having a small film thickness causes the defect as follows. The film thickness may be insufficient when a portion with a small film thickness is polished, and a base plate material made of a steel series or an aluminum series is exposed and the like. Furthermore, the polishing process rises manufacturing cost of the swash plate.

### SUMMARY OF THE INVENTION

The present invention is performed to solve the above problems. Accordingly, it is an object of the present invention to offer methods for forming a film of a high quality on a swash plate for a swash plate type compressor simply and the film formed swash plate.

To achieve the above object, the present invention relates to a method for forming a film, which is made of a film-forming material, on a region where a film is to be formed, of a swash plate for a swash plate type compressor, and has a following feature. The film-forming material is applied to a surface of a transfer plate. The applied surface on the transfer plate is adhered to the region before the film-forming material dries. The film-forming material is bonded to the region by pressing and/or heating the region through the transfer plate. Then the film is formed on the region by peeling the transfer plate from it.

Furthermore, in the present invention the transfer plate is formed so as to fit the shape of the region.

Furthermore, in the present invention the transfer plate is made of resin or metallic film. According to the present invention, the film of a uniform thickness is easily formed.

Furthermore, in the present invention the film-forming material is made of resin containing solid lubricant. The film-forming material containing the solid lubricant is effective to form a film so as to improve slidability.

Furthermore, the present invention has a following feature. An intermediate layer is formed on a region where a film is to be formed, and a film-forming material is applied on the surface of the transfer plate. The applied surface on the transfer plate is adhered to the region through the intermediate layer before the film-forming material dries. When the intermediate layer is formed on the region in advance, it is an easy method to adhere the applied surface of the transfer plate on the region.

Furthermore, in the present invention a film is formed on a plane region of the swash plate. Accordingly, the film of a uniform thickness is easily formed.

Furthermore, in the present invention solvent is added to the resin material, and so the added resin material is applied on the surface of the transfer plate smoothly.

Furthermore, the present invention has a following feature. The film-forming material is applied to the surface of the transfer plate. The region of the preheated swash plate is superimposed on the applied surface of the transfer plate before the film-forming material dries. The film-forming material is bonded to the region. Then the film is formed on the region by peeling the transfer plate from it. According to the present invention, the weight of the swash plate functions as pressure to bond the film-forming material to the region of the swash plate. Accordingly, the pressing process may be omitted.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a partial cross-sectional view illustrating a swash plate type compressor according to an embodiment of the present invention; and

FIG. 2 is a view illustrating a procedure of a method for forming a film according to an embodiment of the present invention.

### DETAILED DESCRIPTION OF THE PREFERRED EMBODIMENTS

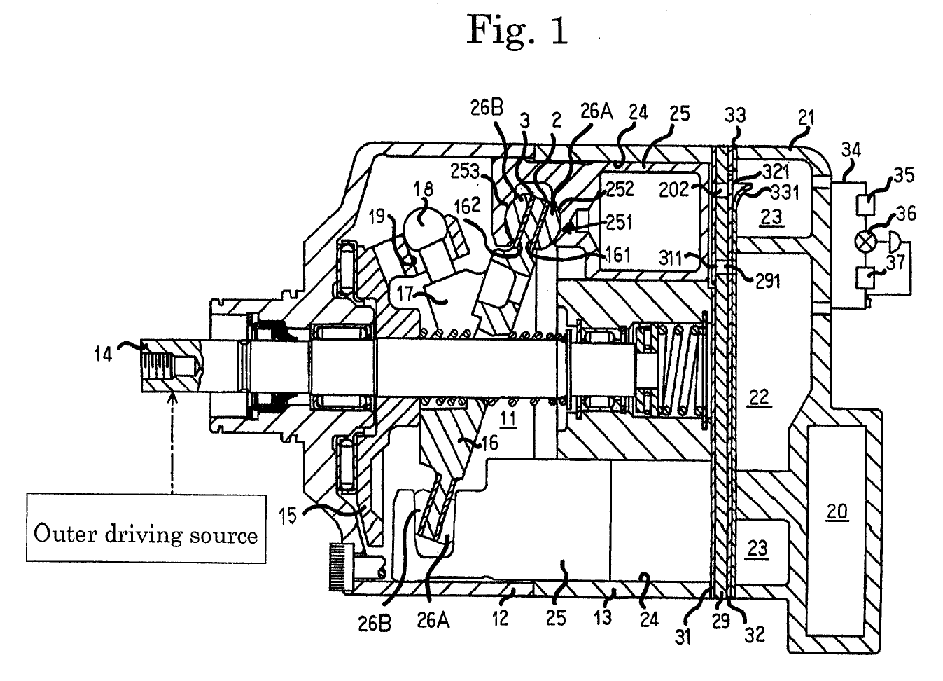

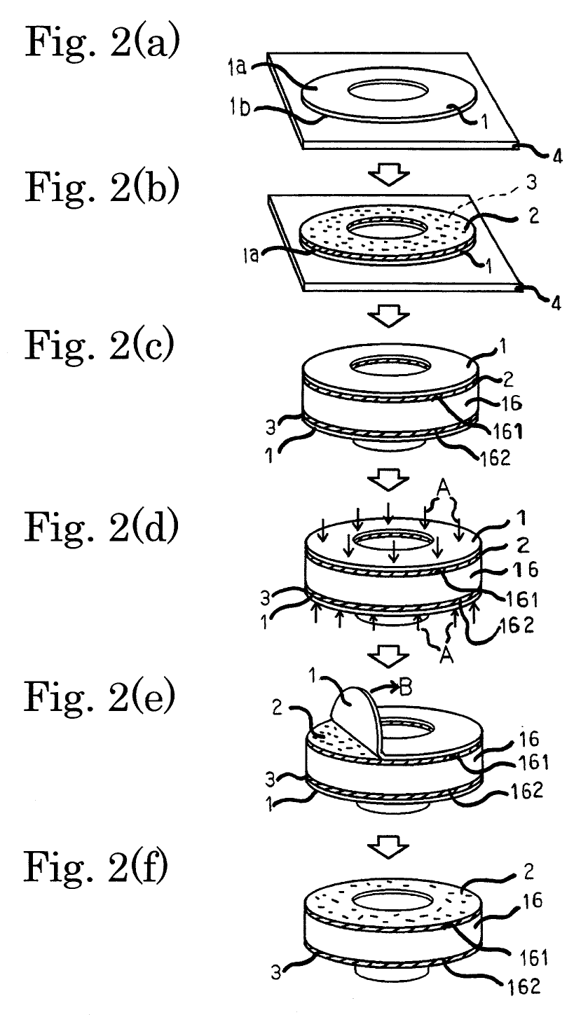

An embodiment according to the present invention will now be described with reference to FIGS. 1 and 2.

A structure of a variable displacement compressor is illustrated in FIG. 1. A drive shaft 14 which receives the drive power from the outer driving source such as a vehicle engine is inserted in a front housing 12 and a cylinder block 13 constituting a crank chamber 11. A lug plate 15 having guide holes 19 is mounted around the drive shaft 14. A swash plate 16 includes a support member 17 on which guide pins 18 are formed. The drive shaft 14 is inserted into a center through hole formed in the swash plate 16 to penetrate therethrough. The swash plate 16 is slidable and inclinable with respect to the drive shaft 14. Each guide pin 18 is slidably engaged in each guide hole 19, respectively, and the swash plate 16 is integrally rotated with the drive shaft 14 through the engagement of the guide pin 18 and the guide hole 19.

The inclination angle of the swash plate 16 depends on the pressure in the crank chamber 11. When the pressure in the crank chamber 11 increases, the inclination angle of the swash plate 16 decreases. When the pressure in the crank chamber 11 decreases, the inclination angle of the swash plate 16 increases. The pressure in the crank chamber 11 is adjusted by a displacement control valve 20, which increases and decreases the flow rate of the refrigerant supplied into the crank chamber 11. In detail, the refrigerant in the crank chamber 11 is released to a suction chamber 22 in a rear housing 21 through a pressure release passage (not illustrated). The refrigerant in a discharge chamber 23 in the rear housing 21 is supplied into the crank chamber 11 through a pressure supply passage (not illustrated). The displacement control valve 20 is arranged in the pressure supply passage, and the flow rate of the refrigerant supplied into the crank chamber 11 from the discharge chamber 23 is increased and decreased by the displacement control valve 20. Accordingly, when the flow rate of the refrigerant supplied into the crank chamber 11 from the discharge chamber 23 increases, the pressure in the crank chamber 11 increases and the inclination angle of the swash plate 16 decreases. When the flow rate of the refrigerant supplied into the crank chamber 11 from the discharge chamber 23 decreases, the pressure in the crank chamber 11 decreases and the inclination angle of the swash plate 16 increases.

A plurality of cylinder bores 24 (only two of the cylinder bores are illustrated in FIG. 1) are arranged around the drive shaft 14 which is located at the radial center of the cylinder block 13. A piston 25 is accommodated in each cylinder bore 24, respectively. As shown in FIG. 1 the piston 25 at the upper side is positioned at the top dead center, and the piston 25 at the lower side is positioned at the bottom dead center. The rotating movement of the swash plate 16 integrally rotated with the drive shaft 14 is converted into the reciprocating movement of the piston 25 through a pair of semispherical shoes 26A and 26B, and the piston 25 reciprocates in the cylinder bore 24.

By the suction stroke of the piston 25 (the movement from right side to left side in FIG. 1), the refrigerant in the suction chamber 22 is introduced into the cylinder bore 24 through a suction port 291 formed on a valve plate 29, pushing away a suction valve 311 formed on a suction valve plate 31. By the discharge stroke of the piston 25 (the movement from left side to right side in FIG. 1), the refrigerant in the cylinder bore 24 is discharged into the discharge chamber 23 through a discharge port 202 formed on the valve plate 29, pushing away a discharge valve 321 formed on a discharge valve plate 32. A retainer 331 formed on a retainer plate 33 regulates the opening degree of the discharge valve 321 by the abutment therebetween.

The discharge chamber 23 and the suction chamber 22 are connected through an external refrigerant circuit 34. The refrigerant in the discharge chamber 23 flows outside the compressor, through a condenser 35, an expansion valve 36 and an evaporator 37 in the external refrigerant circuit 34, and returns to the suction chamber 22.

A connecting portion 251 is formed on the piston 25, and a pair of semispherical concave portions 252 and 253 is formed on the connecting portion 251. Sliding layers 2 and 3 as films are formed on the end surfaces 161 and 162 of the swash plate 16, which are regions where films are to be formed. The sliding layers 2 and 3 slide with the shoes 26A and 26B so as to be sandwiched therebetween. The shoe 26A sliding with one sliding layer 2 of the swash plate 16 is held in the concave portion 252 to be fitted therein, and the shoe 26B sliding with another sliding layer 3 of the swash plate 16 is held in the concave portion 253 to be fitted therein. The sliding layers 2 and 3 are made of a film-forming material, such as a thermosetting resin containing a solid lubricant. The solid lubricants such as molybdenum disulfide, tungsten disulfide and graphite are used. The thermosetting resins such as polyamideimide resins, epoxy resins, phenol resins, polyimide resins and Copna resins are used.

Next, a method for forming a film is described. The procedure for forming a film on the above sliding layers 2 and 3 is illustrated in FIGS. 2(a) to 2(f). As shown in FIG. 2(a), a resin film 1, more preferably a PTFE (polytetrafluoroethylene) film 1 as a transfer plate is placed on a plane plate 4. The PTFE film 1 is preferable to be “Nitoflon film”, marketed by Nitto Denko Co., Ltd. The PTFE film 1 is substantially the same circular as the shape of the end surfaces 161 and 162, which are the region where the film is to be formed, of the swash plate 16 made of steel or aluminum series. A surface 1a and a back surface 1b of the PTFE film 1 are supported on the plane plate 4 so as to be plane and uniform.

As shown in FIG. 2(b) a film-forming material is applied to the surface 1a of the PTFE film 1 with a predetermined thickness (of 50 μm in this embodiment) so as to be substantially uniform by a known method such as a roller coating method, and wet sliding layers 2 and 3 are formed. The film-forming material is made of mainly a solid lubricant and a thermosetting resin, and a small quantity of solvent (N-methyl pyrrolidone in this embodiment) is added so that the film-forming material is smoothly applied.

Then the wet sliding layers 2 and 3 are dried to be half-cured by volatilization of the solvent so that the PTFE film 1 is separated from the layers 2 and 3 finely. As for the condition for drying the sliding layers, it is proven by experiment that it takes two hours at room temperature, one to ten minutes at seventy centigrade, and ten minutes at a hundred and thirty centigrade and the like in this embodiment. In every condition, they are finely separated therebetween. However, considering the productivity, it is desirable to be short time and high temperature.

Next, as shown in FIG. 2(c) the PTFE films 1 on which the half-cured sliding layers 2 and 3 are formed, are adhered to the end surfaces 161 and 162 of the preheated swash plate 16, which are the regions where films are to be formed. Then as shown in FIG. 2(d) the sliding layers 2 and 3 are pressed in the direction of an arrow A uniformly, so that the thickness of the film is performed to be uniform. The half-cured sliding layers 2 and 3 are dried and fixed to the swash plate by heating and pressing, and are perfectly transferred to the end surfaces 161 and 162 of the swash plate 16.

Then as shown in FIGS. 2(e) and 2(f) the PTFE films 1 are peeled from the sliding layers 2 and 3 in the direction of an arrow B, and the dried and fixed sliding layers 2 and 3 formed on the end surfaces 161 and 162 of the swash plate 16 appear. 11 The dried and fixed sliding layers 2 and 3 may be different from each other in its quality, such as the composition of the film-forming material and the thickness of the applied film, because their sliding conditions may be different from each other. Then, the swash plate 16 is sent to a calcination process. The dried and fixed sliding layers 2 and 3 become sliding layers 2 and 3 as a film through the calcination process.

In the above embodiment the following effects can be obtained.

(1) A surface roughness of the PTFE film 1 as the transfer plate is less than 3 μm Rz in accuracy. So, a surface roughness of the sliding layers 2 and 3 applied on the PTFE films 1 is also the similar degree in accuracy. Accordingly, the method for forming the sliding layers 2 and 3 by this PTFE film 1 is effective to obtain easily the uniform sliding layers 2 and 3 having a high surface accuracy as compared with the conventional roller coating method and the like, of which surface roughness is several μm Rz to 30 μm Rz.

(2) When the quantity of the film-forming material to be applied is predetermined in consideration of the change of the film thickness accompanied by calcinating the dried and fixed sliding layers 2 and 3, the surfaces of the calcinated sliding layers 2 and 3 do not need to be polished to adjust the film thickness.

(3) The PTFE film 1 is easy to be peeled for its bendablity, and a small amount of the coating material remains sticked to the film 1 for its high surface accuracy. That is, the PTFE film 1 is finely peeled from the dried and fixed sliding layers 2 and 3 after heated and pressed. Accordingly, the manufacturing process is efficient in working property.

(4) The resin material containing the solid lubricant is effective to form the sliding layers 2 and 3 which can improve the slidability.

(5) The end surfaces 161 and 162 of the swash plate 16 are plane. The adhesion of the PTFE film 1, on which the half-cured sliding layers 2 and 3 are formed, to a plane is easier than an adhesion to a curved surface. Accordingly, the end surfaces 161 and 162 of the swash plate 16, which slide with a pair of shoes 26A and 26B, are suitable for the regions where the sliding layers 2 and 3 as a film are formed by the adhesion of the PTFE film 1 on which the half-cured sliding layers 2 and 3 are formed.

In the present invention the following embodiments also may be applied.

In the above embodiment the PTFE film 1 is applied as the transfer plate. However, a filmy material in a high surface accuracy may be applied. For example, when a resin film made of PET (polyethylene terephthalate) etc., or a metallic film made of chrome steel etc. is applied, the same effect as the above embodiment may also be performed.

In the above embodiment the shape of the PTFE film 1 as the transfer plate is substantially the same circular as the shape of the end surfaces 161 and 162, which are the regions of the swash plate 16 where the films are to be formed. However, the film shape does not need to be the same circular as the shape of the end surfaces 161 and 162. It may include at least the end surfaces 161 and 162 which are the regions where the films are to be formed.

In the above embodiment the sliding layers 2 and 3 are formed on the end surfaces 161 and 162 of the swash plate 16 made of steel series or aluminum series. As disclosed in Japanese Unexamined Patent Publication No. 11-193780 by the applicant of the present invention, however, an intermediate layer such as a metallic welded layer or a plating layer excellent in slidability is formed on the surface of the end surfaces 161 and 162, whereby the sliding layers 2 and 3 according to the present invention may be formed on the intermediate layers. In this case, the sliding layers 2 and 3 are protective films of the intermediate layers.

In the above embodiment the PTFE film 1, on which the half-cured sliding layers 2 and 3 are formed, is adhered to the end surfaces 161 and 162 of the preheated swash plate 16. However, the end surfaces 161 and 162 of the preheated swash plate 16 may be superimposed on the PTFE film 1, on which the half-cured sliding layers 2 and 3 are formed, instead of the above application.

As described above, in the present invention the film-forming material is applied on the surface of the transfer plate so as to fit the shape of the region where the film is to be formed. The applied surface of the transfer plate is adhered to the region by bonding before the film-forming material dries. The film is formed on the region by peeling the transfer plate from it. Therefore, the swash plate for the swash plate type compressor doesn't need to be polished, and the excellent effect that the film of a high accuracy and a high quality is easily formed may be performed.

Therefore the present examples and embodiments are to be considered as illustrative and not restrictive and the invention is not to be limited to the details given herein but may be modified within the scope of the appended claims.

What is claimed is:

1. A method for forming a film on a region where a film is to be formed, of a swash plate for a swash plate type compressor, comprising the steps of:
applying a film-forming material to a surface of a transfer plate;
adhering said applied surface of said transfer plate to said region before said film-forming material dries;
bonding said film-forming material to said region by pressing and/or heating said region through said transfer plate; and peeling said transfer plate from said film.

2. A method for forming a film on a swash plate for a swash plate type compressor according to claim 1,
wherein said transfer plate is formed so as to fit the shape of said region.

3. A method for forming a film on a swash plate for a swash plate type compressor according to claim 1,
wherein said transfer plate is made of resin or metallic film.

4. A method for forming a film on a swash plate for a swash plate type compressor according to claim 1,
wherein said film-forming material is made of resin containing solid lubricant.

5. A method for forming a film on a swash plate for a swash plate type compressor according to claim 1, further comprising the step of:
forming an intermediate layer on said region,
wherein said film-forming material is applied on the surface of said transfer plate,
whereby said applied surface of said transfer plate is adhered to said region through said intermediate layer before said film-forming material dries.

6. A method for forming a film on a swash plate for a swash plate type compressor according to claim 1,
wherein said film is formed on a plane region of said swash plate.

7. A method for forming a film on a swash plate for a swash plate type compressor according to claim 1,
wherein solvent is added to said resin material.

8. A method for forming a film on a swash plate for a swash plate type compressor, comprising the steps of:
applying a film-forming material to a surface of a transfer plate;
superimposing a region where a film is to be formed, of said preheated swash plate on said applied surface of said transfer plate before said film-forming material dries;
bonding said film-forming material to said region; and
peeling said transfer plate from said film.

9. A swash plate for a swash plate type compressor,
said swash plate being obtained by the steps comprising of:
applying a film-forming material to a surface of a transfer plate;
adhering said applied surface of said transfer plate to a region where a film is to be formed, of said swash plate, before said film-forming material dries;
bonding said film-forming material to said region by pressing and/or heating said region through said transfer plate; and
peeling said transfer plate from said film.
